(19) United States
(12) Patent Application Publication
(10) Pub. No.: US 2017/0054734 A1
(43) Pub. Date: Feb. 23, 2017

(54) WORK DESK USAGE MONITORING AND TRACKING SYSTEM AND METHOD EMPLOYING USB DONGLE

(71) Applicant: TOME, INC., Royal Oak, MI (US)

(72) Inventors: Jacob R. SIGAL, Ferndale, MI (US); Massimo BALDINI, Beverly Hills, MI (US); Philip J. DANNE, Royal Oak, MI (US)

(21) Appl. No.: 15/237,036

(22) Filed: Aug. 15, 2016

Related U.S. Application Data
(60) Provisional application No. 62/205,860, filed on Aug. 17, 2015.

(51) Int. Cl. H04L 29/06; G06F 13/10; G06F 13/42; G06F 21/34

(52) U.S. Cl. CPC H04L 63/105; G06F 21/34; G06F 13/102; G06F 13/4282; H04L 67/24

(57) ABSTRACT

The present disclosure relates to a system for tracking usage, as well as type of usage, location and occupancy, of at least one furniture component, for example a desk, in one or more facilities. The system uses a docking station associated with the desk. The docking station has a Universal Serial Bus (USB) expansion port and at least one of a port or a wireless subsystem for enabling a user to make at least one of a wired or wireless connection with the docking station. The docking station communicates with a network and includes a dongle which is coupled to the USB expansion port. The dongle has programmed information stored therein associated with the desk. An application is used which is stored on a user's personal electronic device. The application reads the programmed information when the user establishes a communication link with the network via the docking station. The system also uses a remote subsystem to track usage of the desk by the user.

### CROSS-REFERENCE TO RELATED APPLICATIONS

This application claims the benefit of U.S. Provisional Application No. 62/205,860, filed on Aug. 17, 2015. The entire disclosure of the above application is incorporated herein by reference.

### FIELD

The present disclosure relates to systems and methods for tracking usage of desks in a workplace, and confirming the presence of a user at a specific one of a plurality of available desks at the workplace, and optionally confirming the identity of a user at a specific desk.

### BACKGROUND

The statements in this section merely provide background information related to the present disclosure and may not constitute prior art.

In many workplaces and businesses it is becoming more popular to have non-assigned desks available where any worker is free to sit down with her/his mobile personal electronic device (e.g., laptop), plug the device into a docking station at the work desk, log in to a network and/or the Internet, and begin working. In the industry this is commonly referred to as “hotdesking” and “hoteling”. The individual can thus begin working while her/his personal electronic device (PED) is being charged by the docking station. In addition, present day docking stations typically also have one or more Universal Serial Bus (USB) expansion ports by which an external USB device can be removably connected to the docking station. This permits other devices (e.g., printers, external hard drives, etc.) to communicate with the user's PED through the docking station.

A challenge arises when an entity, for example an employer, operating a workplace where non-assigned desks are available throughout the workplace needs to know and monitor usage of each of the desks, as well as the amount of usage of specific individuals, to determine both vacancy and occupancy times for each desk. This information would be very valuable to the entity for a number of reasons. It may confirm for the entity that desks in various portions of a facility are being occupied (i.e., used) only very little, and that other desks in other areas are heavily used, and that adjustments in where the various desks are placed may be needed. It may also provide information to the entity that the entity can make available to the users, for example through a custom application running on the cell phone of each user, which lets the user know exactly where in a large facility work desks are open and available for immediate use. Such a system would also enable the entity to construct and analyze metrics for work desk usage, as well as the accumulated usage by various individuals, that would facilitate more efficient use of the work desk resources that the entity has available.

### SUMMARY

In one aspect the present disclosure relates to a system for tracking usage of at least one desk in a facility. The system may comprise a docking station associated with the at least one furniture component. The docking station may include a Universal Serial Bus (USB) expansion port, and at least one of a port or a wireless subsystem for enabling a user to make at least one of a wired or wireless connection with the docking station. The docking station may be in communication with a network. The docking station may also include a dongle which is electrically coupled to the USB expansion port. The dongle may have programmed information stored therein associated with the at least one furniture component, and an application adapted to be stored on a user's personal electronic device, the application configured to read the programmed information when the user establishes a communication link with the network via the docking station. The system may further include a remote subsystem for tracking usage of the furniture component by the user.

In another aspect the present disclosure relates to a system for tracking usage of a plurality of desks in a facility. The system may comprise a plurality of docking stations, with each docking station being uniquely associated with one specific desk of the plurality of desks. Each docking station may include a Universal Serial Bus (USB) expansion port, and at least one of a port or a wireless subsystem for enabling a user to make at least one of a wired or wireless connection with the docking station. Each docketing station may further be in communication with a network. A dongle may be included with each docking station and may be electrically coupled to the USB expansion port. The dongle may have a programmed serial number stored therein associated with its respective desk and respective docking station. The system may further include an application which is adapted to be stored on a user's personal electronic device. The application may be configured to automatically read the programmed serial number of the dongle associated with the respective docking station when the user establishes a communication link with the network via the docking station. The system may further include a remote subsystem for real time tracking of usage of all of the desks by a plurality of users, and determining real time availability for use of each one of the desks. Still further, the system may include a server remote from the remote subsystem for communicating with the remote subsystem to obtain information pertaining to real time usage of each one of the plurality of desks from the remote subsystem, and presenting real time information as to an availability or unavailability of each one of the plurality of desks.

In still another aspect the present disclosure relates to a method for tracking usage of at least one furniture component in a facility. The method may comprise using a docking station associated with the at least one furniture component, and using a Universal Serial Bus (USB) expansion port associated with the docking station to enable electrical and mechanical coupling of a dongle thereto. The method may further comprise using at least one of a port or a wireless subsystem operably associated with the docking station for enabling a user to make at least one of a wired or wireless connection with the docking station using a personal electronic device of the user, to thus place the user's personal electronic device in communication with a network. Still further, the method may comprise electrically and mechanically coupling a dongle to the USB expansion port of the docking station, and programming the dongle with information correlating the dongle with the at least one furniture component. Still further, the method may comprise using an application adapted to be stored on the user's personal electronic device to read the programmed information when the user establishes a communication link with the network via the docking station. Still further, the method may comprise using a remote subsystem for tracking usage of the furniture component by the user.

### BRIEF DESCRIPTION OF THE DRAWINGS

The drawings described herein are for illustration purposes only and are not intended to limit the scope of the present disclosure in any way.

FIG. 1 is a high level block diagram of one embodiment of a system in accordance with the present disclosure for monitoring and tracking usage of furniture components, for example desks, in a facility such as a building;

FIG. 2 is one example of a lookup table that may be used to associate the serial numbers of the dongles being used with specific desks; and

FIG. 3 is a flowchart showing one example of various operations that the system and method of the present disclosure may perform in monitoring and tracking usage of a desk by an individual.

### DETAILED DESCRIPTION

The following description is merely exemplary in nature and is not intended to limit the present disclosure, application, or uses. It should be understood that throughout the drawings, corresponding reference numerals indicate like or corresponding parts and features.

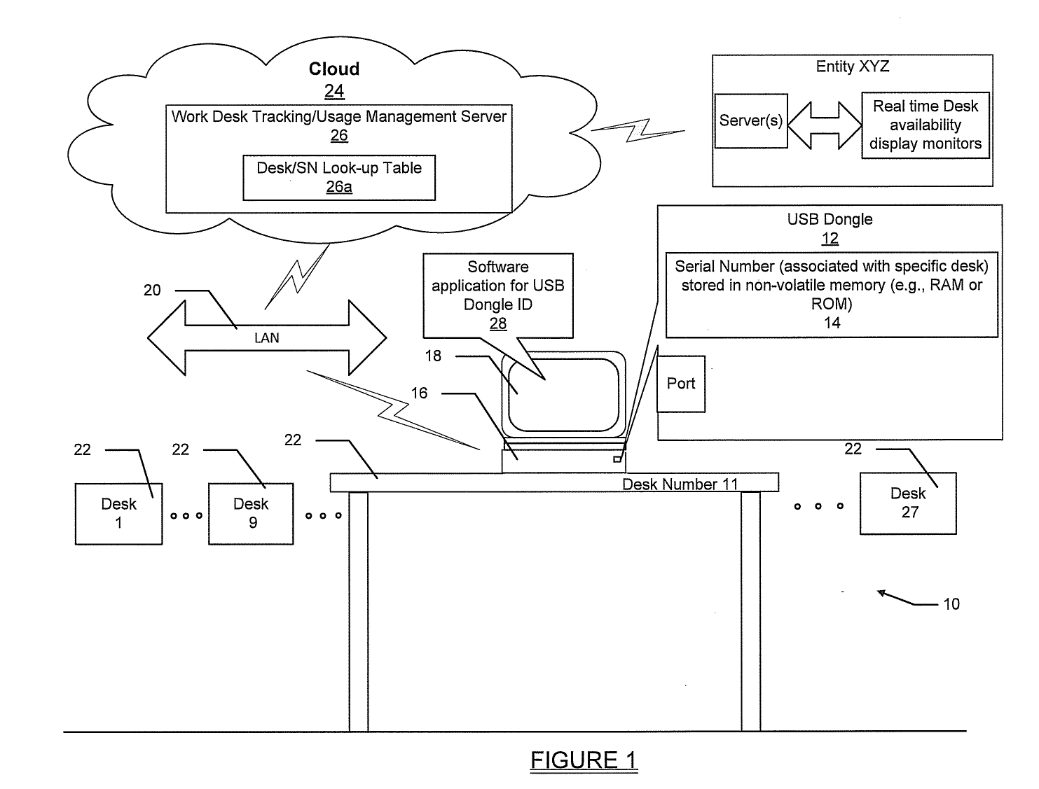

Referring to FIG. 1 there is shown a work desk monitoring and tracking system 10 in accordance with one embodiment of the present disclosure. The system 10 in this example includes a universal serial bus (“USB”) dongle 12 having a serial number stored in a non-volatile memory 14, for example a random access memory or a read only memory. The dongle 12 may be a USB 2.0 or 3.0 protocol dongle, or any other variation associated with USB devices. As such, the dongle 12 is not restricted to use with any particular USB protocol.

The dongle 12 is connected to a docking station 16 having one or more available USB ports. The docking station 16 may be a commercially available docking station that accepts a variety of different laptop computing devices made by different manufacturers. The dongle 12 may be permanently secured to the docking station 16 such that it is not removable. For example, the enclosure or housing for the docking station 16 may enclose the dongle 12 in a way that eliminates easy user access to the dongle, as well as removal of the dongle, but still allow access to other ports on the docking station.

To implement the system 10 it is required that the docking station 16 have at least one USB expansion port. A laptop computing device 18 (hereinafter simply “laptop”) may be removably coupled to the docking station 16 in a conventional manner through an Ethernet cable or any other suitable connection. Once coupled, the laptop 18 is able to communicate with other USB devices, including the dongle 12, which are connected to, or in communication with, the docking station 16. The docking station 16 may be used to make a hardwired connection to a LAN 20, or optionally the laptop 18 may connect to the LAN using a wireless connection. It will also be appreciated that while the following discussion will use the laptop 18 as the PED that is being plugged into the docking station 16, virtually any other type of personal electronic device could be used instead of a laptop, such as a computing tablet, smartphone, etc. As such, the present disclosure is not limited to use with only laptops.

At the facility where the user is making use of the docking station 16, the docking station will be at a specific furniture component, for example a desk 22, and the serial number coded into the non-volatile memory 14 will be associated with that particular desk. In this regard it will be appreciated that while the furniture component is shown as a desk, the present disclosure may be implemented using virtually any type of furniture component that different individuals may be expected to use or occupy or a given time period.

In FIG. 1, desk number 11 is shown in greater detail. Typically the facility may be an office building, or possibly one of several buildings on a corporate or university campus, which have a number of desks available for use by individuals. The number of available desks may vary depending on the size of the building and/or campus, but in some instances there may be dozens or even hundreds of available desks that users may occupy for performing work at the facility. The system 10 is not limited to use with any particular number of desks, and therefore can be thought of as being “modularly” expandable to accommodate additional desks as the entity grows and adds addition desks. The desks 22 in this example are “unassigned”, meaning that any user can occupy any desk that is available when she/he enters the facility at a particular day/time and needs to perform work on a laptop or other PED at the facility. In this example the user has coupled her/his laptop 18 to the docking station 16 at a specific desk 22 designated as “Desk number 11”. The serial number associated with the dongle 12 will be associated with Desk number 11. This information may be stored in a suitable lookup table in memory of a server or other computing device, as will be explained in greater detail in the following paragraphs.

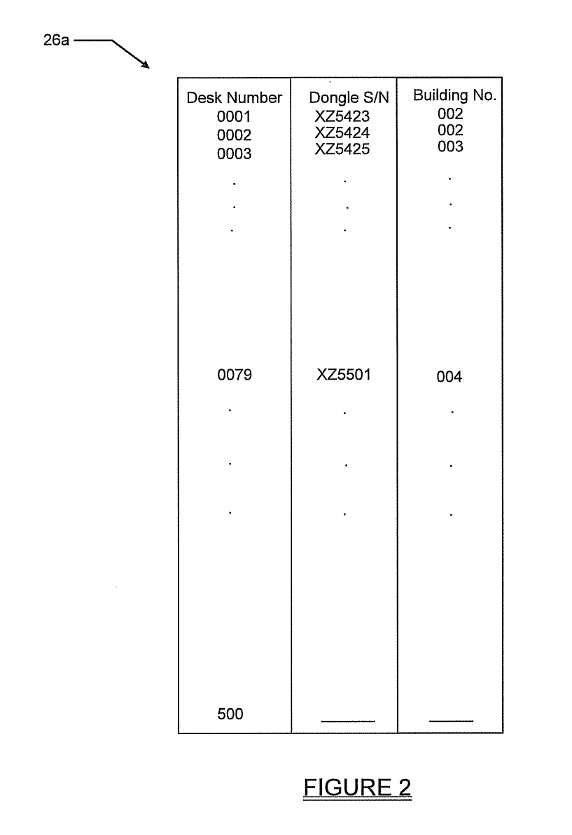

The system 10 may also include a cloud-based subsystem 24. The cloud-based subsystem 24 may include a work desk tracking/usage management server 26 or subsystem (hereinafter simply “management server 26”) which includes a desk/serial number lookup table 26a. The desk/serial number lookup table 26a includes the desk number associated with each serial number of each dongle 12 being used in the system 10. One example of the lookup table 26a is shown in FIG. 2. The look-up table 26a in FIG. 2 includes an optional field for “Building No.” (i.e., Building Number) to associate a particular building with a particular desk 22. Any other pertinent information could also be associated with the docking station 16. For example, if the docking station 16 is located at a desk in an auditorium or conference room, this information could be included in a field of the lookup table and then used to determine and indicate a real time percentage of capacity for the conference room or auditorium. Still further, a department (e.g., sales, engineering, etc.) could be associated with each desk. If different types of desks are used, such as desks that the user would be required to work in a standing position, as well as traditional desks where the user would work in a seated position, are both available for use, then this additional information could also be included in the lookup table 26a. Still further, time zone information could be recorded along with the usage information for each desk if the system 10 is monitoring desks in different buildings, and where the buildings are located in different time zones. Still further, certain desks may be restricted to use during normal business hours, and this information could be included in the lookup table 26a as well.

Similarly, a security clearance could be associated with each desk that would prevent the user from using the docking station 16 at the desk if the user is not able to provide information that ensures that she/he has the appropriate level of security clearance to be authorized to use the desk. And while the management server 26 has been described as being a cloud-based component, it will be appreciated that it need not be cloud-based, but could instead be located in the same building as where the desks 22 are located. Optionally, the management server 26 could be located in a separate building but on the same campus where all the desks 22 are located.

The management server 26 may be in communication with the LAN 20 or with a remotely located server associated with the entity (e.g., Entity XYZ in FIG. 1) that is operating the facility where the desks 22 are located. Optionally, the entity may have one or more “Desk Availability” display monitors set up at various areas in a building (or buildings) where the desks 22 are located. These monitors may be used to display substantially real time desk availability information for all of the desks 22, as well as a general map indicating where the vacant or open desks are available. The terms “vacant desks” or “open desks” will be understood to mean desks that are not being used and thus are available for immediate use. The term “occupied desk” will be understood to mean a desk that is presently being used by an individual. In this way users may quickly determine where specific desks are immediately available for use. This feature may be particularly attractive to users who prefer working at a desk in a particular area of a building or campus. The ability to quickly determine exactly where specific desks are immediately available for use eliminates wasted time when users would otherwise have to walk around a building or campus to find a desk which is available for immediate use.

The information obtained by the management server 26 may be used by the entity responsible for all the desks 22 to track real time usage and availability of the desks 22. Information obtained by the management server 26 may also be used to create metrics on the usage of each desk 22, as well as the usage time of each individual who uses one or more of the desks 22. To facilitate the communication of the stored serial number from the dongle 12 to the management server 26, a software application 28 may be provided that is loaded onto the user's laptop 18. Once the user starts the software application 28, the software application may automatically obtain the serial number from the dongle 12 when the user first connects to the docking station 16, logs in to the network at the facility, and begins using her/his laptop 18. The serial number information may be transferred to the management server 26 during the log-in procedure. Optionally, the dongle 12 could be provided with an “Autoplay” software, but it is expected that using a separate software application, such as software application 28 loaded on the user's laptop 18, will be the preferred approach to determining that a user has occupied a given desk and has begun using the given desk.

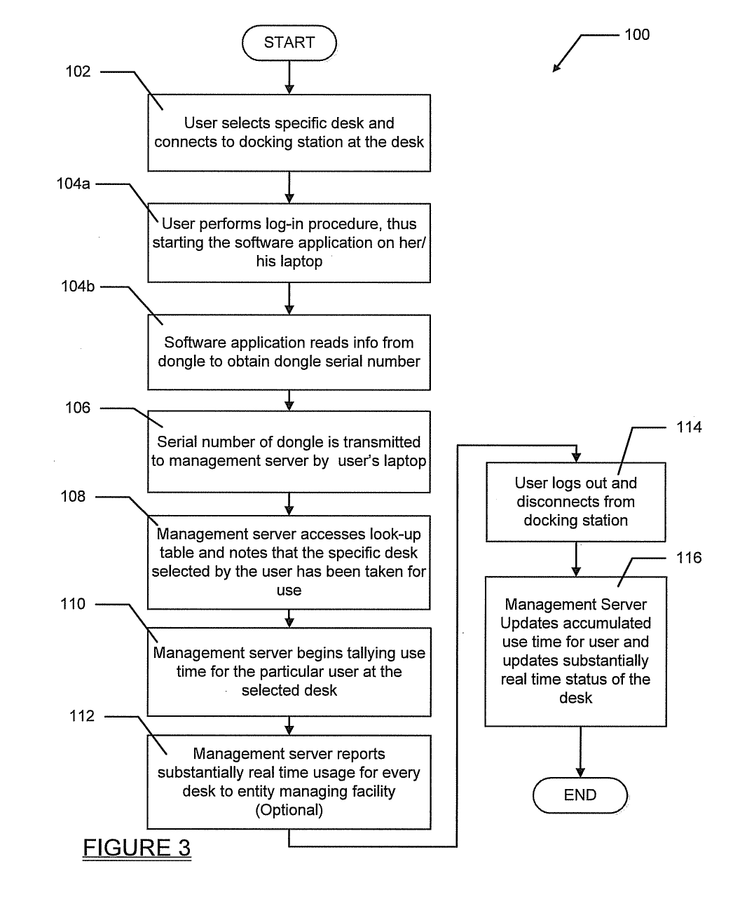

FIG. 3 is a high level flowchart 100 detailing operations that may be performed by the system 10 when the user initially selects a desk 22 for use. At operation 102 the user goes to a specific desk for use and connects to the docking station 16 at the desk 22. At operation 104a the user performs a log-in procedure which starts the software application 28 on the user's laptop 18. Optionally, the software application 28 could be an application that is running on the user's laptop 18 whenever the laptop is powered on. In other words the software application 28 may run in the background on the user's laptop 18 until the user docks the laptop at a specific docking station 16 and begins working at a specific desk 22. It will be appreciated that the software application 28 will at some previous time have been downloaded by the user onto her/his laptop 18. At operation 104b the user's laptop 18 obtains the serial number of the dongle 12.

At operation 106 the serial number associated with the dongle 12 is transmitted via the LAN 20 or otherwise to the management server 26. At operation 108 the management server 26 accesses the look-up table 26a and determines which specific desk 22 has just been taken for use by an individual. Additional identifying information that identifies the individual to the management server 26 is also preferably obtained by the management server to track the accumulated time that each desk 22 has been used by every individual that accesses the system 10, and potentially to help in providing an accumulated total desk usage time for each and every individual who makes use of any of the desks 22. Optionally, the users of the desk could remain anonymous to the system 10, or still further, the system 10 may require identification information only for certain desks 22 located in certain buildings, or certain areas of a building, or possibly for using desks located in certain departments (e.g., finance, sales, etc.).

At operation 110 the management server 26 begins tallying use time for the particular user at the selected desk 22. At operation 112, the management server 26 may optionally report the substantially real time usage of each desk 22 to the entity, which information may be displayed on one or more monitors located at the facility (e.g., building, buildings or campus) that the entity is operating, to assist individuals entering the building (or buildings) in locating open desks which are available for immediate usage. Optionally, the usage information for each desk could be correlated with other occupancy information to verify that the user is actually present and working at a given desk 22. This would eliminate, or at least greatly reduce, the possibility that the system 10 would mistakenly understand that the user is present and working at the desk 22 if the user should leave the desk and her/his laptop for some period of time, for example to take lunch. Other information such as sit/stand times for the user at each desk could also be tracked provided that suitable sensing systems, for example a pressure sensitive floor mat, are employed that sense the presence of an individual at a given desk 22.

At operation 114 the user logs out and disconnects from the docking station 16. At operation 116 the management server 26 then updates the accumulated use time for the desk, and optionally for the user. Optionally, the updating could occur much more frequently, for example once every second, once every minute, etc., to thus provide essentially real time statistical information on the usage of each desk, and on sit/standing times (assuming an occupancy sensor is being employed). When the vacancy/occupancy information is updated in essentially real time or near real time, an accurate status of the desk 22 will always be available to other potential users. Accordingly, other potential users will know virtually immediately that a user has just finished using a specific desk, and that the specific desk is now available for immediate use. This may involve the management server 26 transmitting information to the entity that may be displayed on one or more display monitors at the facility being operated by the entity.

The system 10 and method thus enables the usage of virtually any number of work desks to be tracked within a building or collection of buildings. This enables the entity to easily determine where additional desks could be located to better serve the individuals that use the desks day in and day out. The usage metrics that the system 10 is able to obtain are also expected to valuable to the entity in tracking total accumulated times that each of the desks are used over various time intervals such as weeks, months or years. A particular advantage of the system 10 is that it is expandable as the number of desks in a building or collection of buildings grows.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A system for tracking usage of at least one furniture component in a facility, the system comprising:
a docking station associated with the at least one furniture component, the docking station including:
a Universal Serial Bus (USB) expansion port;
at least one of a port or a wireless subsystem for enabling a user to make at least one of a wired or wireless connection with the docking station, the docking station being in communication with a network;
a dongle electrically coupled to the USB expansion port, the dongle having programmed information stored therein associated with the at least one furniture component;
an application adapted to be stored on a user's personal electronic device, the application configured to read the programmed information when the user establishes a communication link with the network via the docking station; and
a remote subsystem for tracking usage of the at least one furniture component by the user.

2. The system of claim 1, wherein the programmed information comprises a serial number associated with the at least one furniture component.

3. The system of claim 1, wherein the programmed information comprises a building that the at least one furniture component is located in.

4. The system of claim 1, wherein the programmed information comprises a geographic location where the at least one furniture component resides.

5. The system of claim 1, wherein the programmed information comprises a department of an organization that the at least one furniture component is associated with.

6. The system of claim 1, wherein the programmed information includes security clearance information for restricting access to the network to only individuals having a specific level of security clearance.

7. The system of claim 1, wherein the remote subsystem is a cloud based subsystem.

8. The system of claim 1, wherein the application stored on the user's personal electronic device automatically transmits the programmed information via the network when the user logs on to the network.

9. The system of claim 1, wherein the remote subsystem comprises:
a management server having a look up table, and wherein the look up table is used by the management server to identify the at least one furniture component that the user is at when the user logs on to the network via the docking station.

10. The system of claim 9, wherein the management server tracks two or more of:
the time that the user is present and using the at least one furniture component associated with the docking station;
an identity of the user;
a building that the at least one furniture component is present in; and
a stored geographic location of where the at least one furniture component located.

11. The system of claim 10, wherein the management server uses the time that the user is present and using the docking station to help determine an accumulated usage over time of the desk.

12. The system of claim 1, wherein the remote subsystem uses the tracked usage of the docking system to provide real time information to an entity as to availability of the desk for immediate use.

13. A system for tracking usage of a plurality of desks in a facility, the system comprising:
a plurality of docking stations, each said docking station being uniquely associated with one specific desk of the plurality of desks, each said docking station including:
a Universal Serial Bus (USB) expansion port;
at least one of a port or a wireless subsystem for enabling a user to make at least one of a wired or wireless connection with the docking station, the docking station being in communication with a network;
a dongle electrically coupled to the USB expansion port, the dongle having a programmed serial number stored therein associated with its respective said desk and respective said docking station;
an application adapted to be stored on a user's personal electronic device, the application configured to automatically read the programmed serial number of the dongle associated with the respective docking station when the user establishes a communication link with the network via the docking station;
a remote subsystem for real time tracking of usage of all of the desks by a plurality of users, and determining real time availability for use of each one of the desks; and
a server remote from the remote subsystem for communicating with the remote subsystem to obtain information pertaining to real time usage of each one of the plurality of desks from the remote subsystem, and presenting real time information as to an availability or unavailability of each one of the plurality of desks.

14. The system of claim 13, wherein the remote subsystem includes a look-up table for correlating a specific serial number with each one of the plurality of dongles.

15. The system of claim 14, wherein the lookup table further includes a building where each said docking station is located.

16. The system of claim 13, wherein the remote subsystem also stores information which correlates at least one of the following with each one of the plurality of dongles:
a building where each one of the plurality of dongles is located;
a geographic location where each one of the dongles is located;
a time zone in which each one of the dongles is located;
a department which each one of the dongles is associated with; and
a security clearance level associated with each one of the docking stations associated with each one of the plurality of dongles.

17. The system of claim 13, wherein each said dongle is secured to its associated docking station in a manner that prevents a user from detaching the dongle.

18. The system of claim 13, wherein the server determines available capacity of a room based on information provided by each one of the plurality of dongles.

19. The system of claim 13, further comprising a monitor in communication with the server for displaying real time information as to availability of specific ones of the plurality of desks within at least one of a given room or building in which the plurality of docking stations is present.

20. A method for tracking usage of at least one furniture component in a facility, the method comprising:
using a docking station associated with the at least one furniture component;
using a Universal Serial Bus (USB) expansion port associated with the docking station to enable electrical and mechanical coupling of a dongle thereto;
using at least one of a port or a wireless subsystem operably associated with the docking station for enabling a user to make at least one of a wired or wireless connection with the docking station using a personal electronic device of the user, to thus place the user's personal electronic device in communication with a network;
electrically and mechanically coupling a dongle to the USB expansion port of the docking station;
programming the dongle with information correlating the dongle with the at least one furniture component;
using an application, adapted to be stored on the user's personal electronic device, to read the programmed information when the user establishes a communication link with the network via the docking station; and
using a remote subsystem for tracking usage of the furniture component by the user.
